(19) United States
(12) Patent Application Publication
(10) Pub. No.: US 2003/0005298 A1
(43) Pub. Date: Jan. 2, 2003

(54) Method and apparatus for authenticating people using business cards

(76) Inventors: Ned M. Smith, Beaverton, OR (US); Eric R. Dittert, Portland, OR (US); Carl M. Ellison, Portland, OR (US)

Correspondence Address: Pillsbury Winthrop LLP, Intellectual Property Group, Suite 2800, 725 South Figueroa Street, Los Angeles, CA, 90017-5406, US

(21) Appl. No.: 09/895,370

(22) Filed: Jun. 29, 2001

(51) Int. Cl. H04L 9/00

(52) U.S. Cl. 713/171

(57) ABSTRACT

A method for authenticating ownership of cryptographic keys for use in secured digital communication includes creating a key pair. The public key of the key pair is hashed to create a hashed public key. A prover's business card is presented to a verifier with the hashed public key physically imprinted upon the business card. The business card is accepted by the verifier who simultaneously observes the physical characteristics of the prover. Distinguishing characteristics of the prover are associated with the hashed public key. The public key corresponding to the hashed public key is obtained.

### BACKGROUND OF THE INVENTION

1. Field of the Invention

The present invention generally relates to the authentication of people using cryptographic keys to send and receive secure communications. More particularly, the present invention relates to a method of using business cards to authenticate people claiming ownership of cryptographic keys.

2. Discussion of the Related Art

Large scale computer networks such as the Internet and World Wide Web (WWW) have made it possible for companies to automate certain aspects of their businesses, where previously it was not possible or cost effective to do so. Recently developed technologies relating to the Internet have been used to replace earlier forms of communication for doing business (e.g., telephone, fax, mail, and personal meetings). These traditional methods of doing business have historically been supported by norms of behavior and laws that are well understood by the business and legal communities. However, when business entities agree to transact business over the Internet, some of the traditional mechanisms for identifying and enforcing business relationships are replaced by electronic, automated mechanisms. Generally, automation can inadvertently remove physical barriers that help limit exposure to fraud. When one conducts business with another in person, societal norms, as well as legal constructs, help ensure that a transaction is authorized and enforceable. When a transaction is performed over the Internet between two parties (who may not know each other, or know anything about each other), the possibility of fraud increases.

To help battle the increased potential for fraud and unauthorized dealings, business people may utilize an array of security measures, including conducting business through secure communications. One way to effectively secure communication is to use encryption techniques. For example, one user creates a pair of cryptographic keys, one private key that the user keeps secret, and one public key that is distributed through a public domain, such as a Web site or database. When a business person wishes to send the user an encrypted message, he/she will obtain the user's public key, and encode the message with the public key. The sender sends that message over, for example, the Internet. The user receives the message and decodes it using the private key.

If the communication is to be truly secure, the sender must be sure that the person who is claiming ownership of the public key is really who the person says he/she is. This confidence is not always easy in the electronic world where electronic representations of people or things are easily replicated. For instance, George Jones can create an email address for himself at jsmith@myserver.com. He can then send out a message from that email address claiming to be John Smith, and many people may indeed believe that a person named John Smith was sending the message.

Current approaches to make electronic dealings more reliable involve the use of a trusted third party who, in most cases, does not perform physical authentication procedures. Therefore, there is a need for verifying ownership of cryptographic keys by some type of physical authentication.

### DESCRIPTION OF THE DRAWINGS

FIG. 1 illustrates a flow chart diagram showing an operation of authenticating ownership of cryptographic keys according to an embodiment of the present invention; and

FIG. 2 illustrates another flow chart diagram showing an operation of authenticating ownership of cryptographic keys according to an embodiment of the present invention.

### DETAILED DESCRIPTION

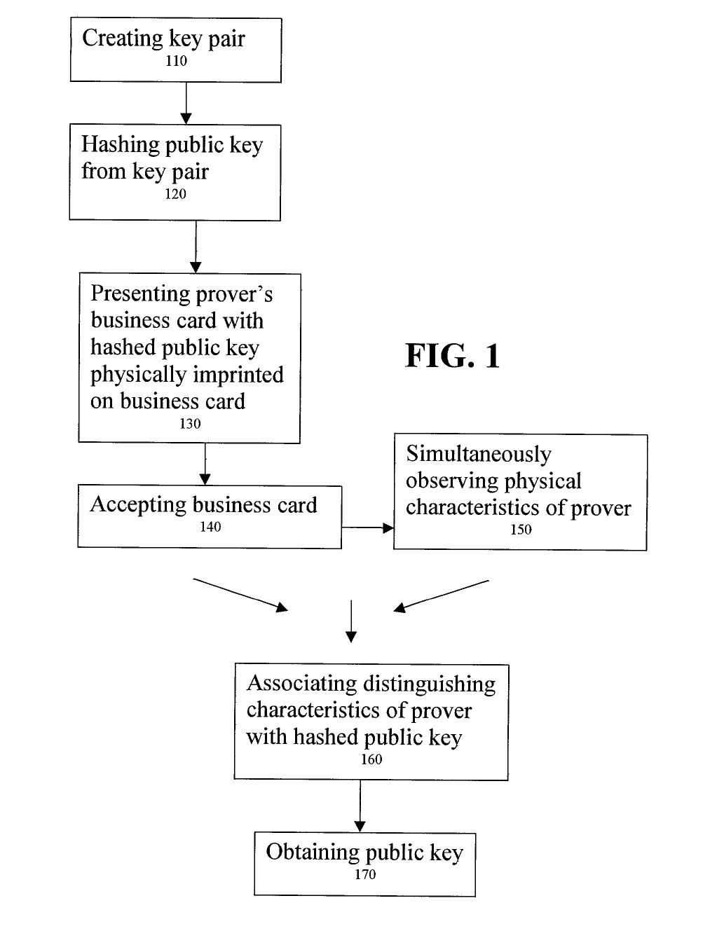

FIG. 1 illustrates a flow chart diagram showing an operation of authenticating ownership of cryptographic keys according to an embodiment of the present invention. The first step in authenticating ownership of cryptographic keys is to create 110 a cryptographic key pair. A user creates a cryptographic key pair so that others may send to the user encrypted communications. A key pair consists of a private key, which is held secret by an individual, hereinafter referred to as a “receiver”, and a public key, which is kept in the public domain. The most common public domain in which public keys are stored is a publicly-accessible Web site or database server. One who wishes to send encrypted communications to a receiver first obtains the receiver's public key and encrypts the communication with it. The encrypted communication travels through a network, most commonly the Internet, to the receiver. The receiver decrypts the communication using his/her private key. The creation of the key pair, also known as asymmetric encryption, may be accomplished by software that is capable of generating a key pair, such as Pretty Good Privacy (PGP). However, any other software program that enables asymmetric encryption may be utilized.

After the key pair has been generated, the public key is hashed 120. The printed public key in ASCII Roman characters would be approximately 500-1000 characters long. Such a value would not be easily represented in the space provided by, for example, a typical business card, which is approximately 9 centimeters×5 centimeters. Additionally, human factor studies suggest that one character in ten results in a clerical error if transcribed manually. To minimize clerical errors and to decrease the size necessary to print a representation of the public key, the public key, which may be of variable-length, may be hashed 120 to produce a fixed-size output of, preferably, 16-20 bytes. The “digested” output may then be represented in approximately 40 characters, resulting in an average of approximately 4 clerical errors per key. The individual that has created the key pair physically imprints the hashed public key upon his/her business card.

An alternative to manual transcription is the use of a bar code, such as the Universal Product Code (UPC). The individual may imprint the UPC bar code representing the hashed public key onto the card in place of, or in addition to, the imprinted alpha and/or numeric value representing the hashed public key. UPC bar code reading devices have error rates an order of magnitude lower than manual transcription. Other suitable bar code schemes than the UPC format may be utilized, though.

The individual then gives 130 his/her business card to another person with the hashed public key imprinted on the card. The individual giving the card is identified as the “prover” because he/she is proving that the hashed public key is associated with him/her self and the name/identification on the business card. The person receiving the business card is known as the verifier because he/she is verifying that the hashed public key is associated with the prover. Once the prover has presented the business card to the verifier, the verifier accepts 140 the business card while simultaneously observing 150 the physical characteristics of the prover. When the verifier observes the physical characteristics of the prover, he/she is visually verifying that the prover indeed exists. This is a vital part of the semantics behind security decisions that may be evaluated electronically.

The verifier then associates 160 distinguishing characteristics of the prover with the hashed public key. Distinguishing characteristics are anything that may be represented electronically and that are sufficient for the verifier to recall the meeting with the prover. The most obvious set of distinguishing characteristics include the contact information on the exchanged business card. Distinguishing characteristics may also include a description of physical characteristics, a digitized photograph, a time and place of the meeting, or nicknames meaningful to the verifier. While electronic representations of people or things are easily replicated, efforts to replicate physical artifacts are more difficult.

The distinguishing characteristics of a prover may be associated directly with a hashed public key, for example, via a “tag” or file that is appended to or is already a part of the hashed public key (or the actual public key itself) that allows the verifier to input comments regarding the hashed public key—such as the address and contact information of the prover (e.g., as determined from the business card), a physical description of the prover (e.g., balding, scar above top left eye, etc.), occupation, or any other distinguishing characteristic. However, any suitable scheme of associating the distinguishing characteristics of a prover with that of the hashed public key, and ultimately, the public key itself, electronically, mentally, or through any other process, may be utilized.

Once the verifier has received the business card with the hashed public key and trusts its authenticity, the verifier may obtain 170 the public key corresponding to the hashed public key. If the hashed public key is imprinted on the card using a UPC symbol or bar code, for example, a bar code scanner or any other scanning device may be utilized to read/scan and input the hashed public key into a software program to obtain the public key. The public key may be obtained, for example, via an Internet Web site or a database server, where the prover provides the public key and the corresponding hashed public key in advance. Once the public key has been obtained, it may be stored in an electronic device or storage device, such as a computer hard drive, a personal digital assistant (PDA), a cellular telephone, an optical disc, etc. The public key may now be used to encode communications to a prover using an encryption software application (such as PGP), and it is associated with the prover.

Moreover, once the distinguishing characteristics of a prover are associated with a hashed public key and it is acceptable to the verifier as being that of the person who presented the hashed public key, the public key corresponding to the hashed public key that is ultimately obtained by the verifier may be further validated by a “signature”. In encryption software programs such as PGP, a file, like that of a public key, may be “signed” with a digital signature utilizing a user's private key. Digital signatures enable the recipient to verify the authenticity of the information's origin, and also verify that the information is intact. So, once the public key has been signed by a verifier using the verifier's private key, the signed public key may be transmitted to another user; and when “decrypted” utilizing the verifier's public key, the other user may determine that the verifier has associated the public key with the prover and may believe that association (to the extent that the other user trusts the verifier).

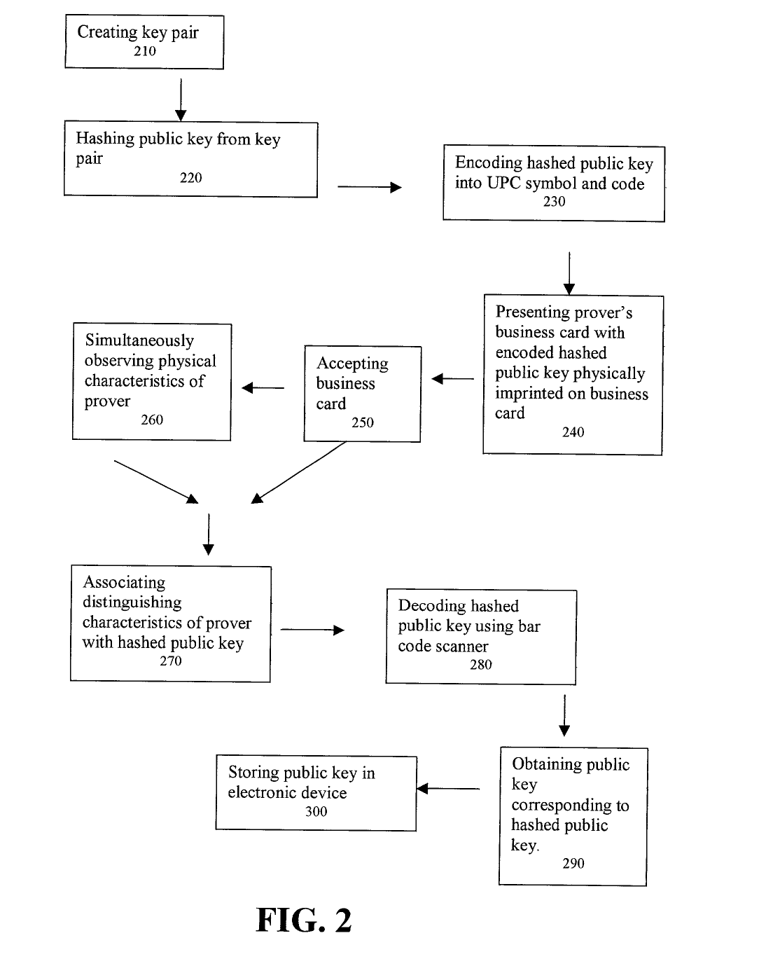

FIG. 2 illustrates a flow chart diagram showing an operation of authenticating ownership of cryptographic keys according to an embodiment of the present invention. Like FIG. 1, the first user creates 210 a key pair and hashes 220 the public key. The hashed public key is encoded 230 into a Universal Product Code (UPC) format. The use of a UPC encoding/decoding device is preferred because it has an error rate an order of magnitude lower than manual transcription. Reasonably inexpensive UPC decoding equipment have been integrated with personal computer (PC) platforms as peripheral devices and may be incorporated into emerging devices, such as pocket PCs, PDAs, and cellular telephones, for example.

After the hashed public key has been encoded 230 into UPC format and imprinted on the prover's business card, the prover presents 240 the business card to a verifier. The verifier accepts 250 the business card and simultaneously observes 260 the physical characteristics of the prover. The verifier then associates 270 distinguishing characteristics of the prover with the hashed public key.

Once the verifier is in possession of the business card and trusts its authenticity, the verifier decodes 280 the hashed public key using a bar code scanner. The hashed public key is used to obtain 290 the public key. The public key may be stored 300 in an electronic device such as a computer hard drive, a personal digital assistant (PDA), an optical disc, or a cellular telephone.

The present invention leverages existing social behaviors that incorporate elements of authentication with electronic artifacts (keys) that allow all subsequent electronic interactions to be valued at least as much as the value associated with the business card exchange. It reinforces accepted levels of authentication in the physical world, for which there is an established legal foundation, but captures that context electronically.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A method of authenticating ownership of cryptographic keys for use in secured digital communication, comprising:
creating a key pair;
hashing a public key from the key pair to create a hashed public key;
presenting a prover's business card with the hashed public key physically imprinted upon the business card to a verifier;
accepting the business card and simultaneously observing physical characteristics of the prover;
associating distinguishing characteristics of the prover with the hashed public key; and
obtaining the public key corresponding to the hashed public key.

2. The method of claim 1, further including storing the public key in a storage device.

3. The method of claim 1, wherein the hashed public key is physically imprinted upon the business card utilizing a bar code.

4. The method of claim 1, wherein the public key is obtained utilizing a bar code scanner and related software to read a bar code representation of the hashed public key.

5. A method of authenticating ownership of cryptographic keys for use in secured digital communication, comprising:
creating a key pair;
hashing a public key from the key pair to create a hashed public key;
encoding the hashed public key into a bar code;
presenting a prover's business card with the bar code physically imprinted upon the business card to a verifier;
accepting the business card and simultaneously observing physical characteristics of the prover;
associating distinguishing characteristics of the prover with the bar code;
decoding the bar code of the hashed public key;
obtaining the public key corresponding to the hashed public key; and
storing the public key in a storage device.

6. The method of claim 5, wherein the storage device is selected from the group consisting of a computer hard drive, a floppy disk, an optical disk, and a personal digital assistant (PDA).

7. A system for authenticating ownership of cryptographic keys for use in secured digital communication, comprising:
a computer-readable storage medium; and
a computer-readable program code, stored on the computer-readable storage medium, having instructions to
create a key pair,
hash a public key from the key pair to create a hashed public key, and
obtain the public key corresponding to the hashed public key physically imprinted on a business card presented by a prover to a verifier, who simultaneously observes physical characteristics of the prover and associates distinguishing characteristics of the prover with the hashed public key.

8. The system of claim 7, wherein the computer-readable program code further includes instructions to store the public key in a storage device.

9. The system of claim 7, wherein the hashed public key is physically imprinted on the business card utilizing a bar code.

10. The method of claim 9, wherein the bar code is in a Universal Product Code (UPC) format.

11. The system of claim 7, wherein a bar code scanner and related software are utilized to read a bar code representation of the hashed public key.

12. The system of claim 11, wherein the bar code is in a Universal Product Code (UPC) format.

13. A system for authenticating ownership of cryptographic keys for use in secured digital communication, comprising:
a computer-readable storage medium; and
a computer-readable program code, stored on the computer-readable storage medium, having instructions to
create a key pair,
hash a public key from the key pair,
encode the hashed public key into a bar code,
decode, using a bar code scanner, the bar code of the hashed public key that is physically imprinted on a business card presented by a prover to a verifier, who simultaneously observes physical characteristics of the prover and associates distinguishing characteristics of the prover with the hashed public key,
obtain the public key corresponding to the hashed public key, and
store the public key in a storage device.

14. The method of claim 13, wherein the storage device is selected from the group consisting of a computer hard drive, a floppy disk, an optical disk, and a Personal Digital Assistant (PDA).

15. A method of authenticating ownership of cryptographic keys from a prover for use in secured digital communication, comprising:
creating a key pair;
hashing a public key from the key pair to create a hashed public key; and
presenting a business card with the hashed public key physically imprinted upon the business card to a verifier, wherein the verifier accepts the business card and simultaneously observes physical characteristics of the prover to associate distinguishing characteristics of the prover with the hashed public key, and the verifier obtains the public key corresponding to the hashed public key.

16. The method of claim 15, wherein the public key is stored in a storage device by the verifier.

17. The method of claim 15, wherein the hashed public key is physically imprinted upon the business card utilizing a bar code.

18. The method of claim 15, wherein the public key is obtained utilizing a bar code scanner and related software to read a bar code representation of the hashed public key.

19. A method of authenticating ownership of cryptographic keys by a verifier for use in secured digital communication, comprising:
accepting a business card having a hashed public key physically imprinted thereupon from a prover and simultaneously observing physical characteristics of the prover, wherein a public key from a key pair is hashed by the prover to create the hashed public key;
associating distinguishing characteristics of the prover with the hashed public key; and
obtaining the public key corresponding to the hashed public key.

20. The method of claim 19, further including storing the public key in a storage device.

21. The method of claim 19, wherein the hashed public key is physically imprinted upon the business card utilizing a bar code.

22. The method of claim 19, wherein the public key is obtained utilizing a bar code scanner and related software to read a bar code representative of the hashed public key.
